(19) United States
(12) Patent Application Publication
(10) Pub. No.: US 2021/0388658 A1
(43) Pub. Date: Dec. 16, 2021

(54) LIFTER PLATE ASSEMBLY WITH FORE/AFT GLASS LOCKING CONFIGURATION

(71) Applicant: MAGNA CLOSURES INC., Newmarket (CA)

(72) Inventors: Milos PAVLOVIC, Kleinburg (CA); Raymond Edward FORTIN, Newmarket (CA); Glenn WANG, Newmarket (CA)

(21) Appl. No.: 17/343,709

(22) Filed: Jun. 9, 2021

Related U.S. Application Data
(60) Provisional application No. 63/039,639, filed on Jun. 16, 2020.

(51) Int. Cl. E05F 11/38; E05F 15/689

(52) U.S. Cl. CPC E05F 11/385; E05Y 2900/55; E05F 2011/387; E05F 15/689

(57) ABSTRACT

A lifter plate assembly for a motor vehicle window and method of assembly thereof is provided. The lifter plate assembly includes a main body having a rail guide hook for sliding receipt of window regulator rails. A pair of opposed spring fingers are disposed in the rail guide hook for biased engagement with the window regulator rails. A resilient cushion supports the spring fingers against yielding to maintain the spring fingers in biased engagement with the widow regulator rails. A window bracket is configured for fixed attachment to a window and has a tongue configured for sliding and snapping receipt in a receptacle of a window retainer plate of the main body. The receptacle has ribs or grooves and the tongue has the other of grooves or ribs, wherein the ribs and grooves interdigitate with one another to prevent relative fore/aft movement between the window bracket the window retainer plate.

### CROSS-REFERENCE TO RELATED APPLICATION

This application claims the benefit of U.S. Provisional Application Ser. No. 63/039,639, filed Jun. 16, 2020, which is incorporated herein by reference in its entirety.

### FIELD

The present disclosure relates generally to vehicle window assemblies, and more particularly to vehicle window assemblies and adjustable window regulator lifter plates therefor.

### BACKGROUND

This section provides background information related to the present disclosure which is not necessarily prior art.

In many motor vehicle door assemblies, an outer sheet metal door panel and an inner sheet metal door panel are connected together to define an internal door cavity therebetween. An equipment module or sub-assembly, commonly referred to as a carrier module, or simply carrier, is often mounted to the inner door panel within the internal door cavity. The carrier typically functions to support various door hardware components, including window regulator rails configured to support lifter plate assemblies for selectively slidable movement therealong, as well as a window regulator motor, often simply referred to as window regulator, to drive the lifter plate assemblies along the window regulator rails. The lifter plate assemblies have lift plates slidably coupled to the window regulator rails and glass brackets fixed to a window to cause the window to slide up and down therewith along the direction of guide channels within the window regulator rails in response to powered actuation of the window regulator.

The lifter plates are generally configured to be coupled to the window guide rail in such a manner so as to provide a predetermined fore/aft range of motion to allow the window to self-adjust and tilt forward (fore), toward a front end of the vehicle, and backward (aft), toward a rear end of the vehicle. Spring fingers are known to be used to allow the fore/aft movement of the window by imparting a predetermined bias against the window regulator rail; however, problems can arise over time as the spring fingers wear and the material of the spring fingers yields. As such, the ability of the spring fingers to exert the spring force needed to hold the window in its intended, “as assembled” position is compromised. As such, over time, the window can become disoriented from its intended position to a position that prevents proper movement of the window between its raised and lowered positions, which can cause the window to become jammed and/or cause a proper seal between the window and periphery against which the window engages to be broken while in a raised position, thereby allowing water to leak past the outer periphery of the window.

The glass bracket that receives the window in fixed relation therewith are known to be snap-fit to the lifter plate body of the lifter plate assembly, with the window being fixed to the glass bracket. The snap-fit between the glass bracket and the window regulator rail of known lifter plate assemblies provides a range of fore/aft motion between the glass bracket and the window regulator rail, thereby introducing further fore/aft movement, in addition to that provided by the coupling of the lifter plate to the window regulator rails, to the window assembly. As such, over time, the ability for the window to become inadvertently moved from its intended orientation in increased.

In view of the above, there is a need to provide lifter plates for a frameless door that are high strength, robust, stiff and durable, while at the same time being lightweight and economical in manufacture and assembly.

### SUMMARY

This section provides a general summary of the disclosure and is not intended to be a comprehensive listing of all features, advantages, aspects and objectives associated with the inventive concepts described and illustrated in the detailed description provided herein.

It is an object of the present disclosure to provide a lifter plate assembly that addresses at least some of those issues discussed above with known lifter plate assemblies.

In accordance with the above object, it is an aspect of the present disclosure to provide lifter plates of a lifter plate assembly that are high strength, robust, stiff and durable, while at the same time being lightweight and economical in manufacture and assembly.

In accordance with the above object, it is an aspect of the present disclosure to provide glass brackets, also referred to as window retainer brackets, of a lifter plate assembly that are high strength, robust, stiff and durable, while at the same time being lightweight and economical in manufacture and assembly.

In accordance with one aspect of the disclosure, the present disclosure is directed to lifter plate assemblies for a window of a motor vehicle door assembly.

In accordance with another aspect of the disclosure, a lifter plate assembly for a window of a motor vehicle has a main body having at least one rail guide hook for sliding receipt of window regulator rails therein; a primary biasing structure for biased engagement with the window regulator rails; and a secondary biasing structure for resisting a change in the bias of the primary biasing structure.

In accordance with another aspect of the disclosure, the primary biasing structure can be provided as a spring member configured for direct engagement with the window regulator rails and the secondary biasing structure can be provided as a resilient member configured to provide support to the primary biasing structure to maintain the primary biasing structure in engagement with window regulator rails.

In accordance with another aspect of the disclosure, the secondary biasing structure can be provided as an elastomeric cushion.

In accordance with another aspect of the disclosure, a lifter plate assembly for a window of a motor vehicle has a main body having at least one rail guide hook. The at least one rail guide hook is configured for sliding receipt of a window regulator rail. The at least one rail guide hook contains a pair of spring fingers, with the spring fingers of the pair of spring fingers opposing one another for biased engagement with the window regulator rail to allow a predetermined amount of fore/aft adjustment of the window. Each of the spring fingers is supported for resilient movement by a resilient cushion, wherein the resilient cushion acts to reassure the associated spring finger remains in biased engagement with the window regulator rail during the useful life of the motor vehicle, thereby assuring the window remains in its intended fore/aft orientation during use.

In accordance with another aspect of the disclosure, the at least one rail guide hook can include a pair of rail guide hooks spaced laterally from one another.

In accordance with another aspect of the disclosure, the main body can be made of plastic.

In accordance with another aspect of the disclosure, the resilient cushions can be molded in bonded relation to the plastic main body of the lifter plate.

In accordance with another aspect of the disclosure, the opposed spring fingers provide a gap therebetween, with the gap being sized for sliding receipt of the window regulator rail therein, such that the opposed spring fingers remain in biased engagement with opposite sides of the window regulator rail.

In accordance with another aspect of the disclosure, the resilient cushions are sandwiched and captured between the spring fingers and the plastic main body.

In accordance with another aspect of the disclosure, the resilient cushions are formed of a rubber material or a rubber-like material, such as a thermoplastic polyurethane (TPU).

In accordance with another aspect of the disclosure, the resilient cushions can be formed having a hollow cavity to enhance their elasticity, while maintaining sufficient resilience to ensure the spring fingers remain engaged with the window regulator rail.

In accordance with another aspect of the disclosure, the lifter plate assembly can be formed including a window retainer plate formed as a monolithic piece of material with the main body, with the window retainer plate having a receptacle configured for receipt of a window bracket.

In accordance with another aspect of the disclosure, the window bracket can be provided having a receptacle configured for fixation of a window edge therein and a tongue configured for receipt in the receptacle of the window retainer plate.

In accordance with another aspect of the disclosure, the tongue can be provided having a detent receptacle and the tongue having a detent, with the detent being configured for locking receipt in the detent receptacle of the tongue.

In accordance with another aspect of the disclosure, the detent receptacle of the tongue can be provided as a through opening configured for snapping receipt of the detent, wherein the detent can be provided as a protrusion of a finger on the window retainer plate to releasably maintain the tongue in the receptacle of the window bracket.

In accordance with another aspect of the disclosure, the through opening can be configured for a clearance fit with the protrusion of the finger to provide a predetermined amount of fore/aft adjustment during assembly, such that the receptacle grooves and the tongue ribs or the receptacle ribs and the tongue grooves can be adjusted in fore/aft relation with one another during assembly.

In accordance with another aspect of the disclosure, to prevent fore/aft movement of the window bracket relative to the window retainer plate, the receptacle can include a plurality of one of receptacle grooves or receptacle ribs and the tongue can include a plurality of the other of tongue grooves or tongue ribs, wherein the receptacle grooves and the tongue ribs interdigitate with one another to prevent fore/aft movement of the window bracket relative to the window retainer plate, or the receptacle ribs and the tongue grooves interdigitate with one another to prevent fore/aft movement of the window bracket relative to the window retainer plate.

In accordance with another aspect of the disclosure, the pair of spring fingers can be snap-fit in the at least one rail guide hook.

In accordance with another aspect of the disclosure, a lifter plate assembly for a window of a motor vehicle can include a main body having a window retainer plate with a receptacle. A window bracket can be provided and configured for fixed attachment to a window and having a tongue configured for sliding receipt in the receptacle of the window retainer plate. The tongue can be configured for snapping receipt of a finger on the window retainer plate to releasably maintain the tongue in fixed attachment with the window retainer plate. The receptacle can include a plurality of one of receptacle grooves or receptacle ribs and the tongue can include a plurality of the other of tongue grooves or tongue ribs. The receptacle grooves and the tongue ribs can be interdigitated with one another to prevent fore/aft movement of the window bracket relative to the window retainer plate, or the receptacle ribs and the tongue grooves can be interdigitated with one another to prevent fore/aft movement of the window bracket relative to the window retainer plate.

In accordance with another aspect of the disclosure, lifter plate assembly can include a pair of spring fingers disposed in at least one rail guide hook in opposed relation with one another for biased engagement with a window rail guide of window regulator rails along which the lifter plate slides for raising and lowering the window, with a resilient cushion disposed beneath each of the spring fingers to facilitate maintaining the spring fingers in biased engagement with the window regulator rails, thereby reducing unwanted fore/aft play, also referred to as slop, of the window.

In accordance with another aspect, there is provided a method of constructing a lifter plate assembly for a window of a motor vehicle, including providing a main body having at least one rail guide hook for sliding receipt of window regulator rails therein, providing a primary biasing structure for biased engagement with the window regulator rails, and providing a secondary biasing structure for resisting a change in the bias of the primary biasing structure when the lifter plate assembly is moved relative to the window regulator rails.

In accordance with another aspect of the disclosure, a method of assembling a lifter plate assembly for a window of a motor vehicle is provided. The method includes a step of providing a window retainer plate having a receptacle including a plurality of one of receptacle grooves or receptacle ribs and a finger; a step of providing a window bracket including a tongue having a plurality of the other of tongue grooves or tongue ribs; a step of aligning the receptacle grooves or receptacle ribs with the tongue grooves or tongue ribs for interdigitation with one another; and a step of sliding the tongue into the receptacle of the window retainer plate and bringing the tongue into snapping engagement with the finger on the window retainer plate to releasably maintain the tongue in fixed attachment with the window retainer plate, wherein the receptacle grooves and the tongue ribs interdigitate with one another to prevent fore/aft movement of the window bracket relative to the window retainer plate, or the receptacle ribs and the tongue grooves interdigitate with one another to prevent fore/aft movement of the window bracket relative to the window retainer plate.

In accordance with a further aspect of the disclosure, the method can further include a step of providing the window bracket having a through opening and providing the finger having a protrusion and snapping the protrusion into the through opening while sliding the tongue into the receptacle.

In accordance with a further aspect of the disclosure, the method can further include a step of providing the through opening and the protrusion having a clearance fit with one another.

In accordance with a further aspect of the disclosure, the method can further include a step of disposing a pair of spring fingers of at least one rail guide hook in biased engagement with window regulator rails for sliding movement therealong and maintaining the spring fingers in biased engagement with the window regulator rails with resilient cushions disposed beneath the spring fingers.

In accordance with a further aspect, there is provided a lifter plate assembly for a window of a motor vehicle, including a main body having a window retainer plate, and a window bracket configured for fixed attachment to a window, wherein the window bracket and the window retainer plate are coupled by a detent device to facilitate fore/aft movement of the window bracket relative to the window retainer plate between a plurality of detent positions.

In accordance with another aspect, there is provided a method of assembling a lifter plate assembly for a window of a motor vehicle, including providing a window retainer plate, providing a window bracket, and coupling the window retainer to the window bracket using a detent device, wherein the detent device is adapted to releasably maintain the window retainer and the window bracket at a plurality of discrete detent positions relative to one another.

Further areas of applicability will become apparent from the description provided herein. The description and specific examples in this summary are only intended to illustrate certain non-limiting embodiments which are not intended to limit the scope of the present disclosure.

### BRIEF DESCRIPTION OF THE DRAWINGS

The drawings described herein are for illustrative purposes only of selected non-limiting embodiments and are not intended to limit the scope of the present disclosure. In this regard the drawings include:

FIG. 1 illustrates a motor vehicle with a door assembly having lifter plate assemblies for a window in accordance with an aspect of the disclosure;

FIG. 2 illustrates a carrier module and lifter plate assemblies of the door assembly of FIG. 1 constructed in accordance with one aspect of the disclosure;

FIG. 3 illustrates the carrier module of FIG. 2 shown assembled to the door assembly of FIG. 1 with a barrier folded back;

FIG. 4 illustrates the carrier module and barrier of FIG. 2 shown fully assembled to the door assembly of FIG. 1;

FIG. 5 illustrates a front side view of a lifter plate of a lift plate assembly in accordance with one aspect of the disclosure;

FIG. 5A illustrates a front side perspective view of the lifter plate of FIG. 5;

FIG. 6 illustrates a front side perspective view of a spring finger assembly of the lifter plate of FIG. 5;

FIG. 7 illustrates an end perspective view of the lifter plate of FIG. 5 shown prior to having the spring finger assembly disposed therein;

FIGS. 8 and 8A illustrate perspective views of a window bracket of the lifter plate assembly disassembled from a window retainer plate of the lifter plate assembly;

FIG. 9 illustrates a perspective view of the window bracket of the lifter plate assembly assembled to the window retainer plate of the lifter plate assembly;

FIG. 10 illustrates a perspective view of the window bracket of the lifter plate assembly;

FIG. 11 illustrates an enlarged top view of a portion of the lifter plate with the window bracket shown cross-sectioned and assembled to the lifter plate; and

FIG. 12 is a flow diagram illustrating a method of assembling a lifter plate assembly for a window of a motor vehicle.

### DETAILED DESCRIPTION OF PRESENTLY PREFERRED EMBODIMENTS

An example embodiment of a motor vehicle closure panel and lifter plate assemblies therefor will now be described more fully with reference to the accompanying drawings. To this end, the example embodiment of a lifter plate assembly is provided so that this disclosure will be thorough, and will fully convey its intended scope to those who are skilled in the art. Accordingly, numerous specific details are set forth such as examples of specific components, devices, and methods, to provide a thorough understanding of a particular embodiment of the present disclosure. However, it will be apparent to those skilled in the art that specific details need not be employed, that the example embodiment may be embodied in many different forms, and that the example embodiment should not be construed to limit the scope of the present disclosure. In some parts of the example embodiment, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

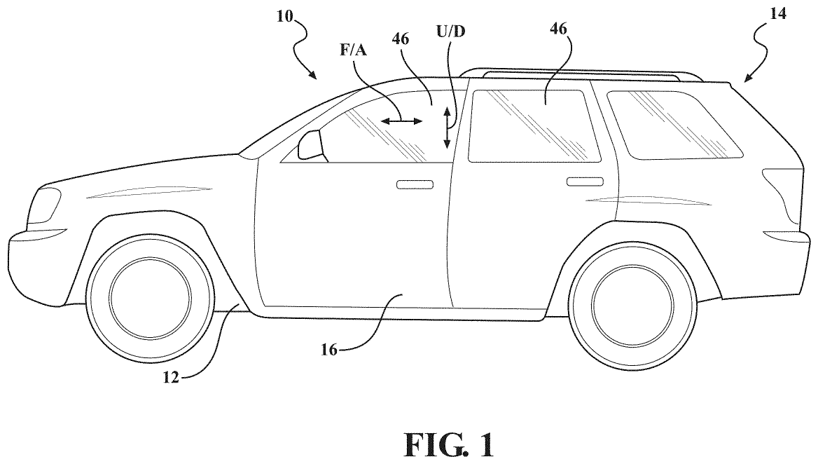

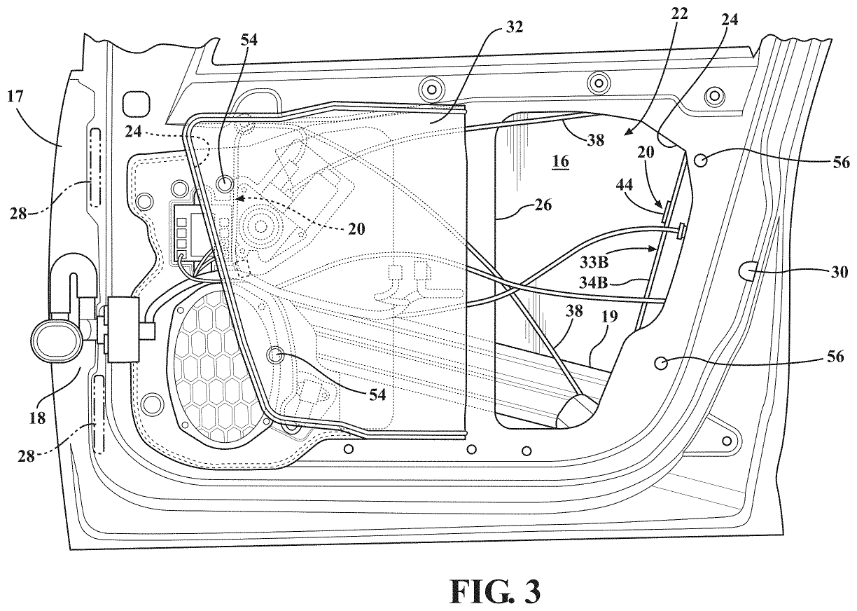

Reference is made to FIG. 1, which shows a door assembly 10 mounted to a body 12 of a motor vehicle 14. The door assembly 10 includes an outer panel 16, an inner panel 18 (FIG. 3), an intrusion member 19 and a door carrier module, shown as a frameless door carrier module, by way of example and without limitation, referred to hereafter simply as carrier 20. Carrier 20 has a pair of carrier members 33A, 33B providing window regulator rails, including, respectively, an A-pillar regulator rail 34A and a B-pillar window regulator rail 34B, and a plurality of door hardware components operably mounted to the carrier members 33A, 33B. In this non-limiting example, at least some of the door hardware includes a power-operated window regulator 36 having an electric motor-driven cable 38 entrained about upper pulleys 40 of each carrier member 33A, 33B and lower pulleys 42 of each carrier member 33A, 33B. Other hardware components shown are well understood by those skilled in the art, and thus, need no explanation, in addition to other components that can be provided, but are not shown. A pair of lifter plate assemblies 44 constructed in accordance with one aspect of the disclosure are supported for sliding movement along guide rails of the separate window regulator rails 34A, 34B for moving a window 46 in an upward/downward U/D direction, as indicated by arrow U/D in FIG. 1, within a pair of glass run channels 48. The glass run channels 48 can be provided separately or formed integrally as a single piece of material with the A and B-pillar carrier members 33A, 33B, such as in a molding operation, by way of example and without limitation. The lifter plate assemblies 44, for reasons discussed further hereafter, are high strength, robust, stiff and durable, while at the same time being lightweight, economical in manufacture and assembly, while exhibiting a long, reliable, useful life.

The outer panel 16 forms at least part of the exterior surface of the door assembly 10. The inner panel 18 provides a structural member for the mounting of one or more trim pieces that form an inner surface of the door assembly 10. Some of the inner panel 18 may itself also form part of the inner surface of the door assembly 10, if desired. The outer and inner panels 16, 18 are connected together to provide a door panel structure 17 that forms an internal door cavity 22 (FIG. 3) that contains various components of the door assembly 10, including at least a portion of the carrier 20. To facilitate assembly of the components into the cavity 22, the inner panel 18 has at least one, and shown as a pair of openings 24, by way of example and without limitation. The openings 24 are shown as being formed on opposite sides of the inner panel 18 with a central support member or rail 26 extending therebetween. The central support rail 26 can be formed as an integral, monolithic piece of material with the inner panel 18, thereby rendering the inner panel 18 economical in manufacture and enhancing the structural integrity, strength and side impact resistance of the inner panel 18. Due to the ability of at least some of the carrier module components, discussed separately hereafter, to be moved relative to one another, and due to the relatively small size of the individual components of the carrier 20, in comparison to the size of the assembled carrier 20, as discussed in more detail below, and further due to the ability to maintain at least a portion of the carrier 20 externally from the internal door cavity 22, the size of the individual openings 24 needed in the inner panel 18 for assembly of the carrier 20 can be minimized. As such, the amount and area of material forming the inner panel 18 can be maximized, thereby increasing the side impact strength of the inner panel 18 relative to inner panels having substantially larger central openings and reduced area.

The outer and inner panels 16, 18 may be made from any suitable material or combination of materials. For example, the outer and inner panels 16, 18 may both be made from a suitable metal (e.g. a suitable steel). In another example, the outer panel 16 may be made from a suitable polymeric or composite material (e.g. fiberglass) and the inner panel may be made from a suitable metal, by way of example and without limitation.

A pair of hinges 28 are connected to door panel structure 17 and pivotally mount a front end of door panel structure 17 (and door assembly 10) to the vehicle body 12. A door latch 30 is mounted to the rear end of door panel structure 17 to permit the releasable closure of door assembly 10 against vehicle body 12. Hinges 28 and door latch 30 act as force transfer members through which forces in door assembly 10 are transmitted to vehicle 14. Such forces include, for example, side-impact forces from another vehicle or object colliding with the vehicle 14.

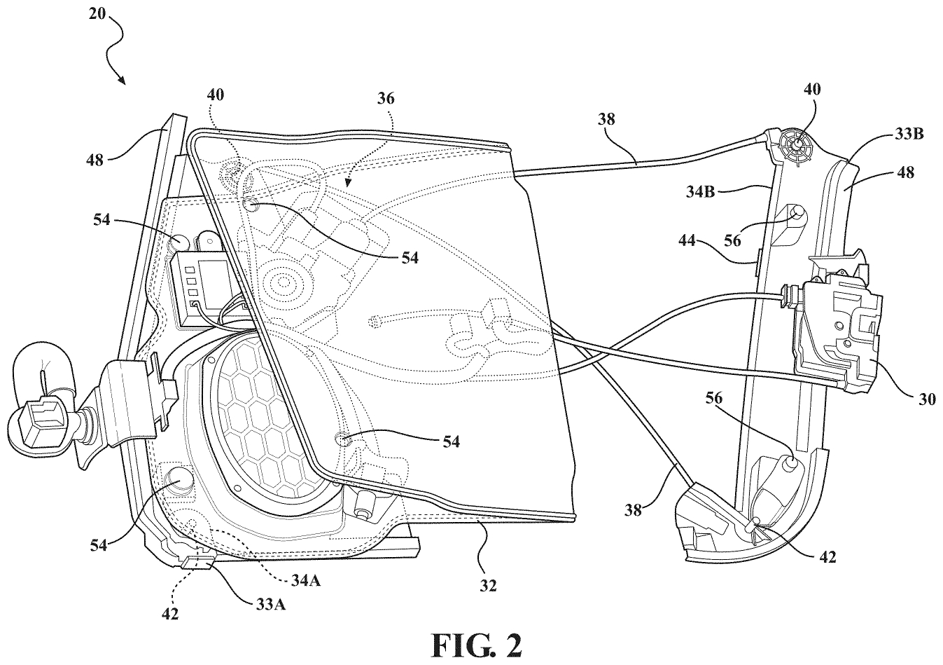

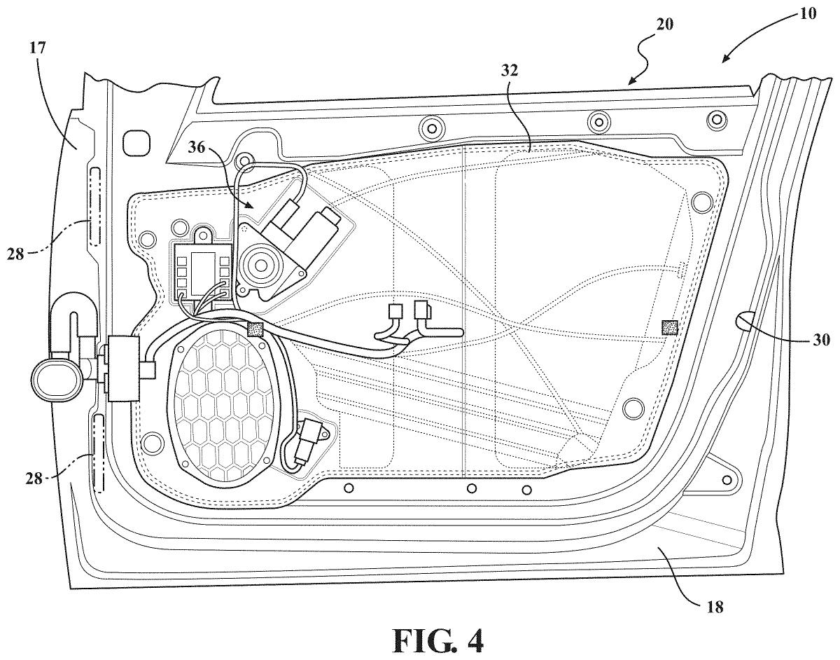

The carrier 20 is shown having a barrier member, shown as being a collapsible barrier member 32, by way of example and without limitation, attachable to the A and B-pillar carrier members 33A, 33B of carrier 20, though their orientation could be reversed, if desired. The barrier member 32, intended to function both as a fluid (water) barrier and as a sound barrier, can be formed of any suitable fluid/sound barrier material, as desired, in order to meet the necessary specifications. Further, in order to facilitate assembly, including ensuring the barrier member 32 is properly located and fixed in sealed relation relative to the inner panel 18, the barrier member 32 can be formed with locating features 54, shown by way of example as female recesses, configured for mating engagement with corresponding locating features 56, shown by way of example an male protrusions (FIGS. 2-4), on at least one of the separate carrier members 33A, 33B. The locating features 54, 56 can be formed to provide a snug, interference fit with one another.

In accordance with a further non-limiting embodiment, A-pillar carrier member 33A and B-pillar carrier member 33B can be constructed entirely of plastic, thereby being relatively lightweight as compared to a similar structure made of metal, e.g. steel, and also being economical in manufacture, such as via a molding process, by way of example and without limitation, as well as being rigid and durable.

In accordance with an aspect of the disclosure, the lifter plate assemblies 44 have a lifter plate 49 including a lifter plate main body, referred to hereafter as main body 50, which can be formed entirely of plastic material, such as in an injection molding process, by way of example and without limitation. Within the main body 50, a plurality of relatively thin walls, also referred to as ribs 58 (only a few identified for simplicity), and a plurality of cavities, also referred to as voids 60 (only a few identified for simplicity), are formed, shown as extending about at least a portion of an outer periphery, with the ribs 58 providing the enhanced strength, rigidity and durability aspects to the lifter plate assemblies 44, and the voids 60 providing the lightweight aspect, in addition to the plastic material of the main body 50, along with reducing overall cost of material and enhancing economies of manufacture in the molding process. The plurality of voids 60 are bounded by the ribs 58 of the plastic material, wherein the ribs 58 can be shaped and configured as desired, and are shown configured in a crisscross-patterned wall configuration to both reduce the weight, while at the same time, enhance the strength and rigidity of the lifter plate assembly 44. The ribs 58 can be sized having a desired length, height and width, and can be arranged as desired to provide optimal strength and rigidity for the intended application. Accordingly, it is contemplated herein that other than configuring the ribs 58 as shown, other moldable patterns could be used, such as an array of circular, non-circular, triangular, honeycomb, and rectangular walls, or any other geometric configuration of walls desired.

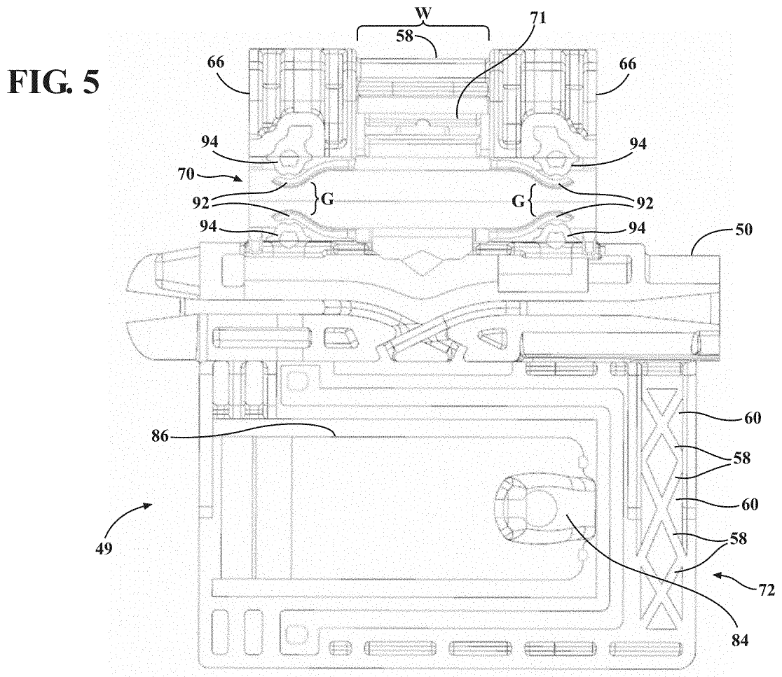

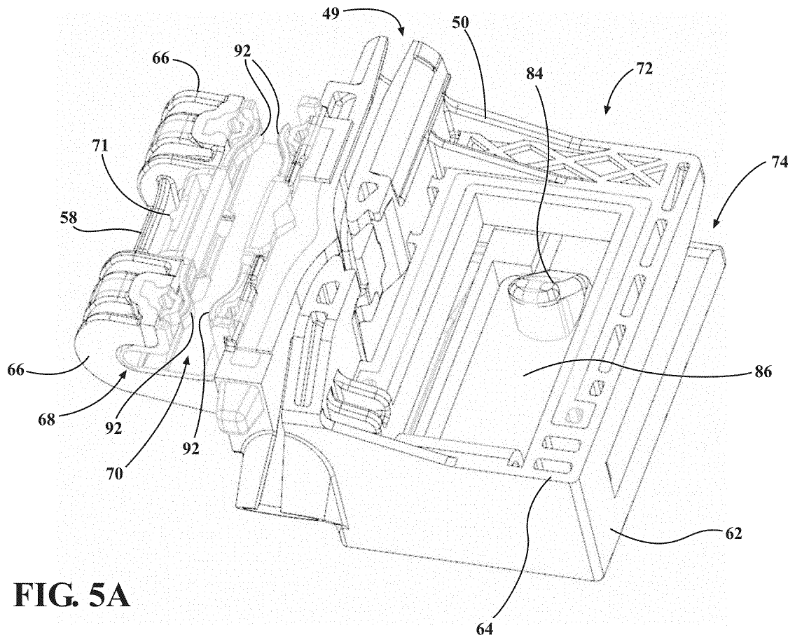

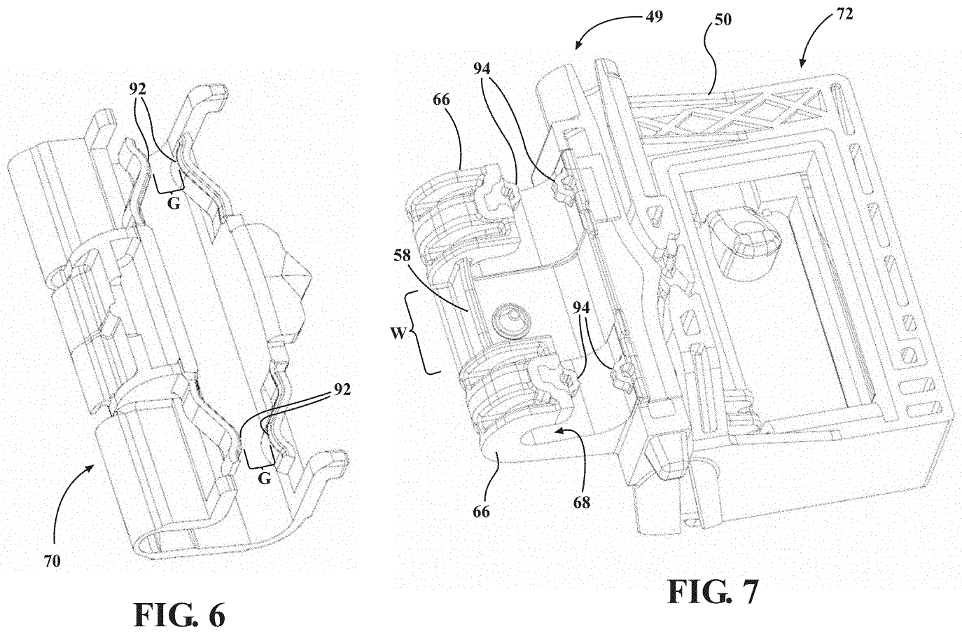

The lifter plate 49 has an inner side 62 facing toward the cavity 22 and an outer side 64 facing away from the cavity 22 of the door panel structure 17. The lifter plate main body 50 includes a pair of rail guide hooks 66 formed therein, wherein the rail guide hooks 66 can be formed having any suitable shape configured for sliding receipt of window regulator rails 34A, 34B therein, such as to form a generally L-shaped slot 68, or otherwise, with the slots 68 being shaped to retain the window regulator rails 34A, 34B therein. The rail guide hooks 66 are laterally spaced from one another by a gap, also referred to as window W (FIGS. 5 and 7), and are shown as having at least one rib 58 extending therebetween in directed molded attachment therewith to provide enhanced strength, rigidity and stability to the rail guide hooks 66. As such, although the rail guide hooks 66 are formed of lightweight plastic with the main body 50, they are substantially rigid to facilitate smooth sliding along the window regulator rails 34A, 34B. To further facilitate smooth sliding along the window regulator rails 34A, 34B, and to facilitate maintaining proper alignment of the lifter plate assembly 44 and window 46 supported thereby in a fore/aft direction, as indicated by arrow F/A in FIG. 1, a lubricious spring finger insert 70, such as bushing grade lubricious polymeric or metallic material, by way of example and without limitation, can be disposed to line the entire inner surface of the rail guide hooks 66, and to extend therebetween. Thus, the spring finger insert 70 can be formed as a single, monolithic piece of material to line the pair of the laterally spaced rail guide hooks 66, wherein the spring finger insert 70 can be disposed via a snap-fit or puzzle-like assembly with the main body 50; however, the finger insert 70 can also be insert molded, or otherwise bonded to the main body 50. To facilitate attaining and maintaining the desired alignment and fit of the spring finger insert 70 within the laterally spaced rail guide hooks 66, the spring finger insert 70 can include a locating feature 71, shown as a tab sized for snug or line-to-line receipt within the window W extending between the spaced rail guide hooks 66. The tab 71 is disposed in snug-fit relation within the window W during assembly, whereupon the spring finger insert 70 can be simply rolled into snap-fit and/or snug, fixed relation within the L-shaped slot 68 defined by the rail guide hooks 66, similar to fitting pieces of a puzzle together.

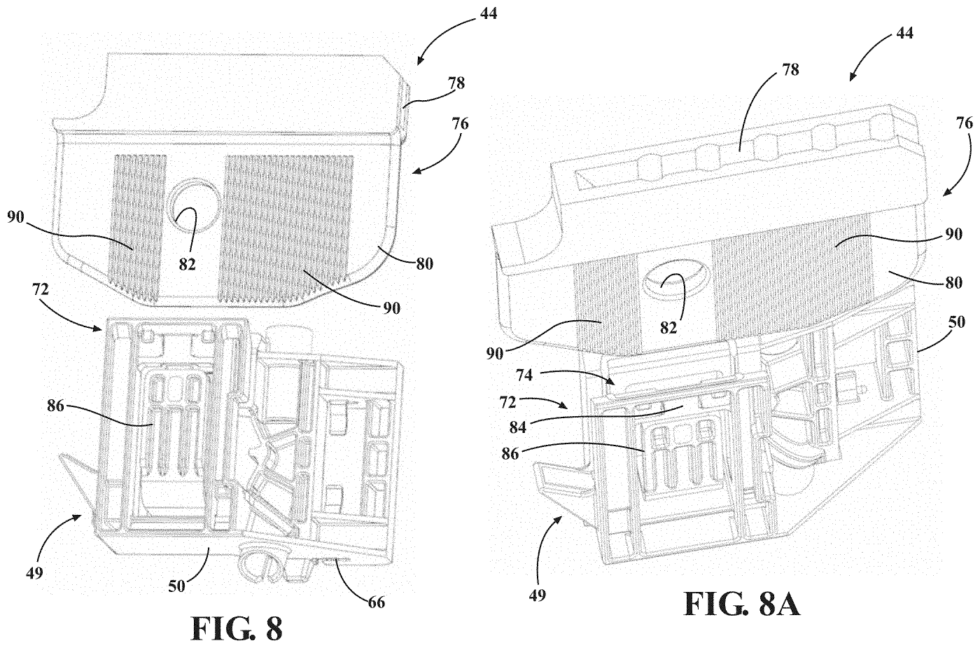

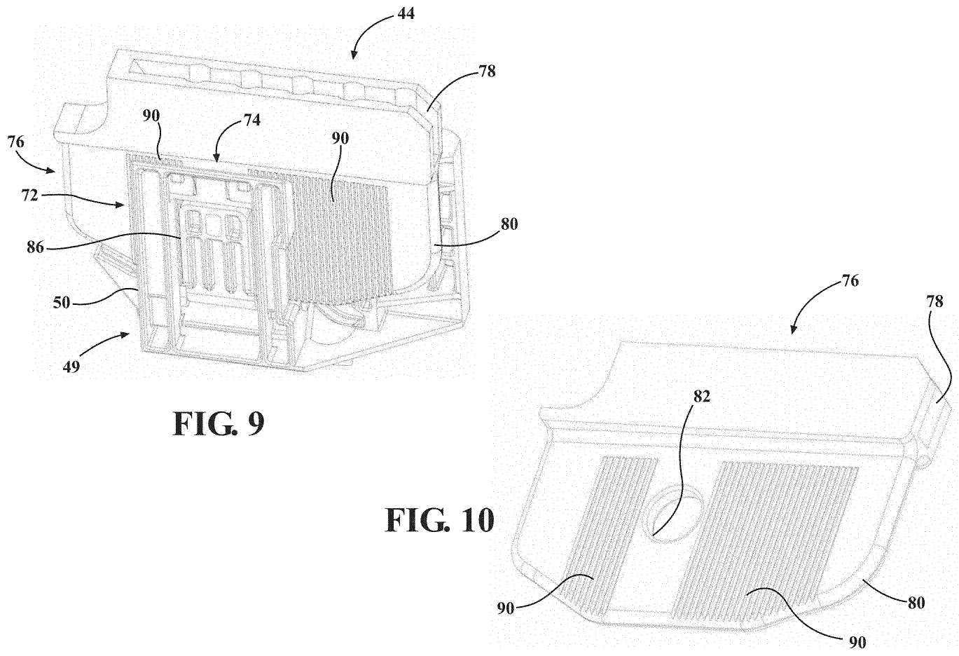

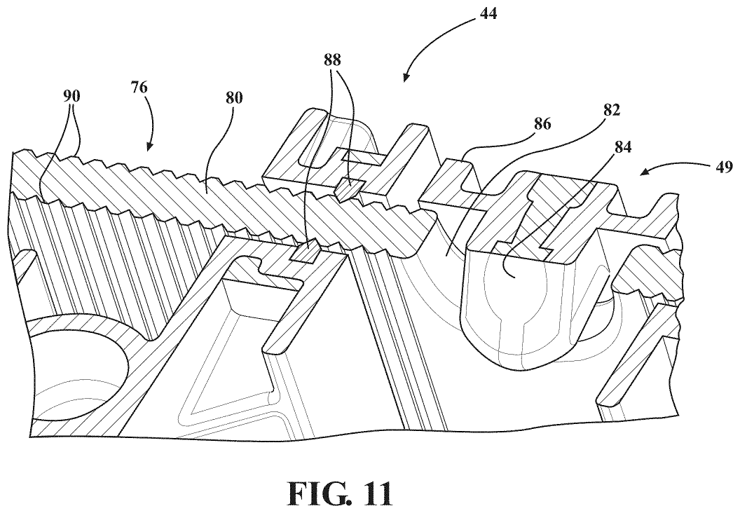

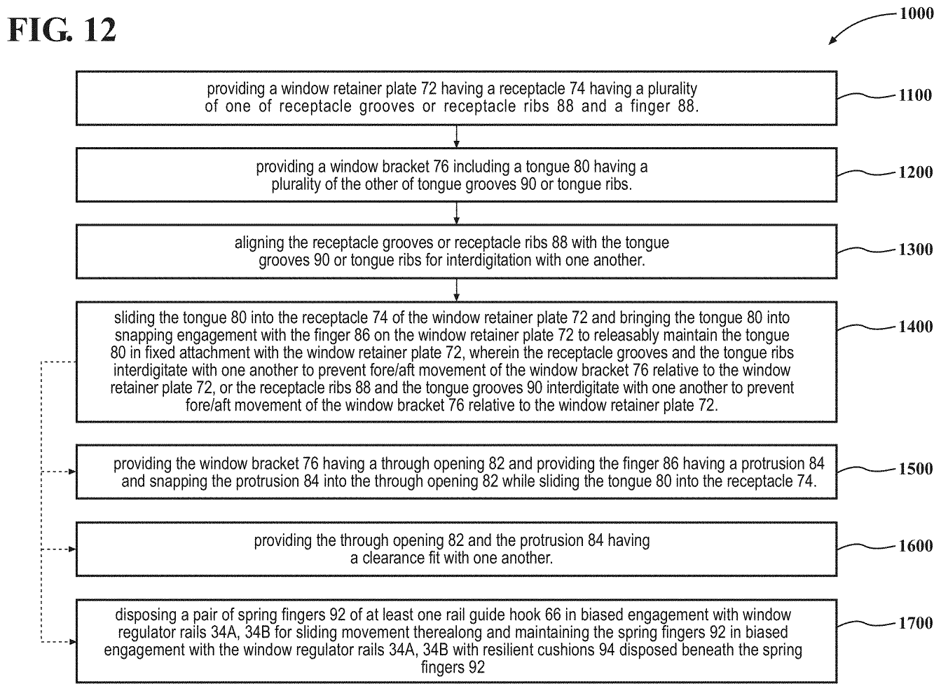

The lifter plate 49 further includes a window retainer plate 72 formed of the plastic material of the main body 50 to provide a receptacle 74 configured for receipt of a window bracket 76 (FIGS. 8-11). As such, the window retainer plate 72 can be formed as a monolithic piece of material with the main body 50. The window bracket 76 has a window receptacle 78 (FIGS. 8A and 9) configured for fixation of a bottom or lower edge of window 46 therein and a generally planar tongue 80 configured for receipt in the receptacle 74 of the window retainer plate 72. The tongue 80 is shown, by way of example and without limitation, as having a detent receptacle, shown as through opening 82, though a recessed pocket or dimple is contemplated herein, configured for snapping receipt of a detent, shown as a protrusion 84 (best seen in FIG. 11) of a resilient finger 86 on the window retainer plate 72 to releasably maintain the tongue 80 in the receptacle 74. The resilient finger 86 is shown cantilevered on the window retainer plate 72 for flexing during assembly and resilient snapping disposal of the protrusion 84 into the through opening 82 upon assembly. To prevent inadvertent fore/aft movement of the window bracket 76 relative to the window retainer plate 72 after assembly of the window bracket 76 to the window retainer plate 72, the receptacle 74 can include a plurality of one of receptacle grooves or receptacle ribs, and shown as receptacle ribs 88, by way of example and without limitation, and the tongue 80 can have a plurality of the other of tongue grooves or tongue ribs, and shown as tongue grooves 90, by way of example and without limitation, wherein the receptacle ribs 88 and the tongue grooves 90 interdigitate with one another to prevent, or the receptacle ribs and the tongue grooves (not shown) interdigitate fore/aft movement of the window bracket 76 relative to the window retainer plate 72 with one another to prevent fore/aft movement of the window bracket 76 relative to the window retainer plate 72. The receptacle ribs 88 and the tongue grooves 90 are an example of a detent mechanism coupling to allow or facilitate fore/aft movement of said window bracket 76 relative to said window retainer plate 72 between a plurality of detent positions. The detent mechanism provides for selective locking and releasing of window bracket 76 relative to said window retainer plate 72 when a for/aft force is respectively removed from or applied to the window bracket 76 through for/aft adjustment of the window 46 for example.

In accordance with a further aspect of the disclosure, the window brackets 76 of the lifter plate assemblies 44 can be preassembled to the window 46 as a subassembly, whereupon final assembly is made easy by only having to slidably insert the window brackets 76 into the window retainer plates 72. As the receptacle ribs 88 slide within the tongue grooves 90, the window bracket 76 is prevented from moving fore/aft relative to the window retainer plate 72, and upon the protrusion 84 being snapped into the through opening 82, the window bracket 76 and window 46 fixed thereto are prevented from being pulled outwardly from the window retainer plate 72. It should be recognized that the fore/aft adjustment can be easily performed during assembly by positioning the window brackets 76 in the desired position relative to the window retainer plates 72 such that the receptacle ribs 88 are received in the proper tongue grooves 90 to result in the desired fore/aft position of the window 46, with sufficient clearance between the protrusion 84 and the through opening 82 being provided to allow for fore/after adjustment. Accordingly, if during assembly it is determined that the window 46 needs to be moved in one of the fore or aft directions, the protrusion 84 can be intentionally moved outwardly from the opening 82 via application of a suitable external biasing force on the finger 86, and then the window bracket 76 can be pulled in sliding, straight linear fashion upwardly along the U/D direction out from the receptacle 74 of the window retainer plate 72; moved to the desired fore/aft position, and then reinserted in sliding, straight linear fashion downwardly along the U/D direction into the receptacle 74 to bring the tongue grooves 90 in to mating receipt with corresponding receptacle ribs 88, whereat the window bracket 76 is again locked against fore/aft movement in a direction transverse to the upward/downward U/D direction relative to the window retainer plate 72, and whereupon the resilient finger 86 is biased for resilient snapping disposal of the protrusion 84 into the through opening 82, thereby eliminating any relative movement or potential degrees of freedom between the window bracket 76 and the lifter plate 49.

The spring finger inserts 70 include resilient spring fingers 92 configured to remain in biased engagement with the window regulator rails 34A, 34B, with the spring fingers 92 being able to be deflected in the fore/aft F/A direction to allow a predetermined amount of desired fore/aft adjustment/movement of the window 46. The spring finger inserts 70 are one possible embodiment of a primary biasing structure for biased engagement with the window regulator rails 34A, 34B to allow for float or movement between the lifter plate 49 and the window regulator rails 34A, 34B, for example in the event the rails 34A and 34B are not exactly parallel to one another, or in other words to allow or facilitate the lifter plate 49 to move from an aligned, nominal, position with the window regulator rails 34A, 34B. The primary biasing structure can be configured to apply a bias directly against the window regulator rails 34A, 34B to assist with the return of the lifter plate 49 from the misaligned position to the aligned position with the window regulator rails 34A, 34B. The primary biasing structure can allow for temporary misalignment between the lifter plate 49 and the window regulator rails 34A, 34B as a result of a fore/aft F/A direction of the lifter plate 49 causing a change in the biasing of the primary biasing structure (for example such as a compression or decompression of spring finger inserts 70 in response to a for/after movement of the lifter plate 49) and facilitate alignment, or re-alignment, of the lifter plate 49 and the window regulator rails 34A, 34B. The primary biasing structure may in addition to a spring finger construction, include other types of resilient structures such as prongs or spring structures such as a leaf spring configuration, or composite multi-material bumpers such as a “D” shaped bumper as non-limiting examples, which can be affixed, connected, integral, overmolded, or molded with the main body 50. Each of the spring fingers 92 is supported in backed-up fashion for enhanced resilient movement by a resilient bumper, also referred to as resilient member or resilient cushion 94. The resilient cushion 94 are examples of a secondary biasing structure for resisting a change in the bias of the primary biasing structure. For example the secondary biasing structure can resist the yielding of the primary biasing structure during for/aft movement of the lifter plate 49. The secondary biasing structure may be configured to engage directly with the primary biasing structure after a certain degree of yielding of the primary biasing structure to prevent or resist further yielding of the primary biasing structure. Alternatively, the secondary biasing structure may act to resist the yielding of the primary biasing structure during all degrees of yielding of the primary biasing structure. Accordingly, the secondary biasing structure can remain in constant supporting engagement with the primary biasing structure. The secondary biasing structure can act to reinforce the primary biasing structure to reduce the degree of yielding of the primary biasing structure to avoid the loss of spring rate of the primary biasing structure tending to contribute to misalignment and slop between the lifter plate 49 and the rails 34A, 34B. The secondary biasing structure can act to change the resiliency characteristics, such as the spring characteristics, of the primary biasing structure. The resilient cushion 94 beneath each spring finger 92, in backing-up relation therewith, acts to reassure the associated opposed pairs of spring fingers 92 remain spaced opposite one another to provide a desired, predetermined gap G therebetween. For example, without the resilient cushion 94, the material of the spring fingers 92, being subject to creep over time, would be inclined to separate away from one another, thereby allow the gap G to increased, thereby promoting undesirable fore/aft movement of the window 46. However, with the resilient cushions 94, the gap G is able to be more reliably maintained and sized for sliding receipt of a window rail guide of the window regulator rail 34A, 34B therein, such that the opposed pairs of spring fingers 92 avoid creep and remain in biased engagement with opposite sides of the window rail guide of the window regulator rail 34A, 34B over the useful life of the motor vehicle 14. The resilient cushions 94 impart a “backup” spring bias outwardly on the overlying spring finger 92, such as when the spring fingers 92 are deflected during temporary fore/aft movement of the lifter plate 49 and window 46 fixed thereto. Accordingly, the resilient cushions 94 function to assist the spring fingers 92 in assuring the lifter plate 49; window bracket 76 and window 46 return and remain in their intended, “as assembled” fore/aft orientation after any temporary fore/aft deflection of the lifter plate 49 and window 46 occurs. As such, the lifter plate assembly 44 provides a single degree of freedom, located between the spring fingers 92 of the lifter plate 49 and the guide rail of the window regulator rails 34A, 34B, for temporary fore/aft movement of the lifter plate 49 and window 46 during use. As such, the fore/aft movement and return of the lifter plate 49 and window 46 to its desired, “as assembled” fore/aft position upon release of a window fore/aft deflecting force is tightly controlled. Accordingly, the only play (degree of freedom) in the lifter plate assembly 44 is between the spring fingers 92 of the lifter plate 49 and the guide rail of the window regulator rails 34A, 34B.

The resilient cushions 94 can be molded of an elastically resilient rubber material or a rubber-like material, such as a thermoplastic polyurethane (TPU) in bonded relation to the plastic main body 50 of the lifter plate 72, such as in an overmolding process, or any other molding process. However, it is contemplated herein that the resilient cushions 94 could also be pre-formed and subsequently bonded to the lifter plate 49, such as via a suitable adhesive, if desired. To enhance the elastic compressibility of the resilient cushions 94, the resilient cushions 94 can be formed having an internal hollow cavity 96, shown as through openings extending through the resilient cushions 94 (identified in FIGS. 8A-8C), while maintaining sufficient resilience to ensure the spring fingers 92 resist creep and remain spaced from one another over the predetermined gap G in engaged relation with the window rail guide of the window regulator rail 34A, 34B.

In accordance with another aspect of the disclosure, a method 1000 of assembling a lifter plate assembly 44 for a window 46 of a motor vehicle 14 is provided. The method 1000 includes a step 1100 of providing a window retainer plate 72 having a receptacle 74 having a plurality of one of receptacle grooves or receptacle ribs 88 and a finger 88; a step 1200 of providing a window bracket 76 including a tongue 80 having a plurality of the other of tongue grooves 90 or tongue ribs; a step 1300 of aligning the receptacle grooves or receptacle ribs 88 with the tongue grooves 90 or tongue ribs for interdigitation with one another; and a step 1400 of sliding the tongue 80 into the receptacle 74 of the window retainer plate 72 and bringing the tongue 80 into snapping engagement with the finger 86 on the window retainer plate 72 to releasably maintain the tongue 80 in fixed attachment with the window retainer plate 72, wherein the receptacle grooves and the tongue ribs interdigitate with one another to prevent fore/aft movement of the window bracket 76 relative to the window retainer plate 72, or the receptacle ribs 88 and the tongue grooves 90 interdigitate with one another to prevent fore/aft movement of the window bracket 76 relative to the window retainer plate 72.

In accordance with a further aspect of the disclosure, the method 1000 can further include a step 1500 of providing the window bracket 76 having a through opening 82 and providing the finger 86 having a protrusion 84 and snapping the protrusion 84 into the through opening 82 while sliding the tongue 80 into the receptacle 74.

In accordance with a further aspect of the disclosure, the method 1000 can further include a step 1600 of providing the through opening 82 and the protrusion 84 having a clearance fit with one another.

In accordance with a further aspect of the disclosure, the method 1000 can further include a step 1700 of disposing a pair of spring fingers 92 of at least one rail guide hook 66 in biased engagement with window regulator rails 34A, 34B for sliding movement therealong and maintaining the spring fingers 92 in biased engagement with the window regulator rails 34A, 34B under a bias imparted by resilient cushions 94 disposed beneath the spring fingers 92. It is to be understood that the pair of spring fingers 92 of the at least one rail guide hook 66 are provided as discussed above, thereby being fabricated of a lubricious material and subsequently fixed within the L-shaped slot 68 of the rail guide hooks 66, which are formed as an integral, monolithic piece of material with the main body 50 of the lifter plate assembly 44, such as via snap-fitting the spring fingers 92 into fixed relation within the rail guide hooks 66, or otherwise, as discussed above.

While the above description constitutes a preferred embodiment of the present invention, it will be appreciated that the present invention is susceptible to further modification and change without departing from the fair meaning of the accompanying claims.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A lifter plate assembly for a window of a motor vehicle, comprising:
a main body having at least one rail guide hook for sliding receipt of window regulator rails therein;
a primary biasing structure for biased engagement with the window regulator rails; and
a secondary biasing structure for resisting a change in the bias of the primary biasing structure.

2. The lifter plate assembly of claim 1,
wherein said primary biasing structure is a pair of spring fingers disposed in said at least one rail guide hook in opposed relation with one another for biased engagement with the window regulator rails;
wherein said secondary biasing structure is a resilient cushion beneath each of said spring fingers, said resilient cushion imparting a bias on said spring fingers to maintain said spring fingers in biased engagement with the widow regulator rails; and
wherein said resilient cushions are sandwiched between said main body and said spring fingers.

3. The lifter plate assembly of claim 1, wherein said resilient cushions have hollow cavities.

4. The lifter plate assembly of claim 1, wherein said resilient cushions are bonded to said main body.

5. The lifter plate assembly of claim 1, wherein said main body has a pair of said at least one rail guide hook spaced laterally from one another.

6. The lifter plate assembly of claim 1, wherein said main body is plastic.

7. The lifter plate assembly of claim 6, wherein said resilient cushions are rubber or a rubber-like material.

8. The lifter plate assembly of claim 7, wherein said spring fingers are formed of a lubricious material.

9. The lifter plate assembly of claim 1, further including a window retainer plate formed as a monolithic piece of material with said main body, said window retainer plate having a receptacle with a resilient finger; and
a window bracket configured for fixed attachment to a window, said window bracket having a tongue configured for sliding receipt in said receptacle of said window retainer plate, said tongue being configured for snapping engagement with said finger to releasably maintain said tongue in fixed attachment with said window retainer plate.

10. The lifter plate assembly of claim 9, wherein said window bracket has a detent receptacle and said finger has a detent, said detent being configured for snapping receipt in said detent receptacle.

11. A lifter plate assembly for a window of a motor vehicle, comprising:
a main body having a window retainer plate; and
a window bracket configured for fixed attachment to a window,
wherein said window bracket and said window retainer plate are coupled by a detent device to allow fore/aft movement of said window bracket relative to said window retainer plate between a plurality of detent positions.

12. The lifter plate assembly of claim 11,
wherein the window retainer plate includes a receptacle;
wherein the detent device includes a tongue of the window bracket configured for sliding receipt in said receptacle of said window retainer plate, and a finger of the window retainer plate, said tongue being configured for snapping receipt of the finger on the window retainer plate to releasably maintain said tongue in fixed attachment with said window retainer plate;
a plurality of one of receptacle grooves or receptacle ribs of said receptacle and a plurality of the other of tongue grooves or tongue ribs of said tongue, wherein said receptacle grooves and the tongue ribs interdigitate with one another to prevent fore/aft movement of said window bracket relative to said window retainer plate, or said receptacle ribs and said tongue grooves interdigitate with one another to prevent fore/aft movement of said window bracket relative to said window retainer plate; and
wherein said window bracket has a detent receptacle and said finger has a detent, said detent being configured for receipt in said detent receptacle.

13. The lifter plate assembly of claim 12, wherein said detent receptacle is a through opening and said detent is a protrusion, said detent receptacle and said protrusion having a clearance fit with one another.

14. The lifter plate assembly of claim 11, wherein said main body at least one rail guide hook for sliding receipt of window regulator rails therein;
a pair of spring fingers disposed in said at least one rail guide hook in opposed relation with one another for biased engagement with the window regulator rails; and
a resilient cushion beneath each of said spring fingers.

15. The lifter plate assembly of claim 11, wherein said resilient cushions are bonded to said main body.

16. The lifter plate assembly of claim 11, wherein said pair of spring fingers are snap fit in said at least one rail guide hook.

17. A method of assembling a lifter plate assembly for a window of a motor vehicle, comprising:
providing a window retainer plate having a receptacle having a plurality of one of receptacle grooves or receptacle ribs and a finger;
providing a window bracket having a tongue having a plurality of the other of tongue grooves or tongue ribs;
aligning the receptacle grooves or receptacle ribs with the tongue grooves or tongue ribs for interdigitation with one another; and
sliding the tongue into the receptacle of the window retainer plate and bringing the tongue into snapping engagement with the finger on the window retainer plate to releasably maintain the tongue in fixed attachment with the window retainer plate, wherein the receptacle grooves and the tongue ribs interdigitate with one another to prevent fore/aft movement of the window bracket relative to the window retainer plate, or the receptacle ribs and the tongue grooves interdigitate with one another to prevent fore/aft movement of the window bracket relative to the window retainer plate.

18. The method of claim 17, further including providing the window bracket having a through opening and providing the finger having a protrusion and snapping the protrusion into the through opening while sliding the tongue into the receptacle.

19. The method of claim 18, further including providing the through opening and the protrusion having a clearance fit with one another.

20. The method of claim 17, further including disposing a pair of spring fingers of at least one rail guide hook in biased engagement with window regulator rails for sliding movement therealong and maintaining the spring fingers in biased engagement with the window regulator rails with resilient cushions disposed beneath the spring fingers.
